(19) United States
(12) Patent Application Publication
(10) Pub. No.: US 2013/0302584 A1
(43) Pub. Date: Nov. 14, 2013

(54) Foam Assembly And Method Of Making The Same

(71) Applicants: Daniel J. LaFlamme, Wixom, MI (US); Ronald G. Bedro, Plymouth, MI (US); Srinivasa Sanku, Northville, MI (US); David J. Hayes, West Bloomfield, MI (US)

(72) Inventors: Daniel J. LaFlamme, Wixom, MI (US); Ronald G. Bedro, Plymouth, MI (US); Srinivasa Sanku, Northville, MI (US); David J. Hayes, West Bloomfield, MI (US)

(21) Appl. No.: 13/978,539

(22) PCT Filed: Jan. 11, 2012
(86) PCT No.: PCT/US12/20928

§ 371 Date: Jul. 29, 2013

Related U.S. Application Data
(60) Provisional application No. 61/433,018, filed on Jan. 14, 2011.

(51) Int. Cl. B32B 5/18

(52) U.S. Cl. CPC B32B 5/18
USPC 428/218; 264/45.1

(57) ABSTRACT

A foam assembly for use as an interior component in an automobile includes a foam core having a hard foam portion and a soft foam portion. The hard foam has a first density to provide firmness and support to the foam core and the soft foam has a second density that is less than the first density, to provide comfort and feel to the foam core. The foam assembly may further including an impervious barrier that is disposed between the hard foam and the soft foam to maintain separation between the hard foam and the soft foam.

### CROSS-REFERENCE TO PRIOR APPLICATIONS

This U.S. National Stage Patent Application claims the benefit of International Application Serial No. PCT/US2012/020928 filed Jan. 11, 2012 entitled “A Foam Assembly And Method Of Making The Same,” which claims the benefit of U.S. Provisional Patent Application Ser. No. 61/433,018 filed Jan. 14, 2011, entitled “Method Of Making A Foam Assembly,” the entire disclosures of the applications being considered part of the disclosure of this application and hereby incorporated by reference.

### BACKGROUND OF THE INVENTION

1. Field of the Invention

The subject invention relates to a method of making a foam assembly or foam core for use in connection with interior components such as head restraint components, seat components and/or interior panels.

2. Description of the Related Art

Conventional foam assemblies or seat assemblies of the type commonly found in the related art typically include a seatback assembly, a lower seat assembly, a recliner mechanism as well as certain safety features such as seatbelts and head restraints. Head restraints, seatbacks, seat bottoms and other interior components such as interior trim panels, booster seats and armrests typically include a foam hardness providing some form of comfort and/or support to the occupant.

Such interior components are typically made with a foam core and an exterior surface including, in some cases, an exterior coverstock of leather. The foam can be made of many types of materials including, for example, polyurethane having a certain density to thereby provide a predetermined amount of cushion hardness.

Further, as one example of a seat assembly, head restraint assemblies include a post and a bun attached to the post. The post is provided for adjustably mating with the seatback. The bun is typically molded to the post and provided for support and comfort of the occupant. The bun includes a foam core and in some applications, a coverstock. The foam core provides a cushioned yet resilient soft-touch feature to the head restraint assembly. In addition, the foam core receives the head and neck portions of the occupant for support purposes in the event of an impact. The size and shape of the foam core is designed based on many other factors including, for example, seat size, occupant size, and the minimum amount of safety dampening expected of the foam core in the event of an impact.

Head restraint assemblies are typically made in a mold process wherein the foam core is molded onto the head restraint post. The mold includes a bowl and a lid. The bowl is designed to provide the final shape of the foam core after completion of the mold process. The lid includes a fixture for receiving the head restraint post prior to sealingly closing the lid onto the bowl.

During the method of forming a head restraint assembly having a post and bun, the post is inserted into the fixture on the lid, foam (such as a polyurethane) is poured into the bowl, the lid is closed thereby causing the post to be disposed in the foam in a predetermined manner, heat is applied over a predetermined amount of time to the bowl and lid mold assembly, thereby causing the foam to adhere to the post while being hardened into the corresponding shape of the bowl and corresponding lid. After such predetermined time has passed, the lid is opened and the post having the foam molded thereto forming the bun is removed from the lid fixture to thereby provide a finally formed head restraint assembly.

It has been found that more than one foam can be used in connection with forming an interior component such that a varying comfort (cushion hardness) can be provided to the occupant.

### SUMMARY OF THE INVENTION

The present invention provides for a method of making an interior component having a foam core with a soft foam and a hard foam including, for example, a head restraint assembly having a post and a bun wherein the foam used to form the foam core for the bun includes a soft foam and a hard foam. The method begins by distributing a hard foam having a first density into a mold. The first density of the hard foam is a higher density foam that provides firmness and support to the foam core. Next, a soft foam having a second density is distributed into the mold. The second density of the soft foam is a lower density foam that is less than the first density of the hard foam and provides comfort and feel to the foam core. Lastly, the mold is heated to solidify the hard foam and soft foam to form the foam core. The foam assembly may further include an impervious barrier that is disposed between the hard foam and the soft foam to separate the hard foam and the soft foam.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view of a vehicle having an exemplary seating assembly according to the subject invention;

FIG. 2 is a perspective view of an exemplary seating assembly according to the subject invention;

FIG. 3 is a front view of a head restraint assembly having a bun and a post, shown in phantom, formed integral with the bun;

FIG. 4 is a perspective view of the bun having a portion removed to show the foam core of the bun;

FIG. 5 is a perspective view of an exemplary mold used to form a head restraint assembly according to the subject invention;

FIG. 6 is a side view of the exemplary mold used to form a head restraint assembly according to the subject invention;

FIG. 7 is a cross-sectional view of the exemplary mold used to form a head restraint assembly and having a hard foam, a film and a soft foam disposed therein to form the head restraint assembly according to the subject invention;

FIG. 8 is a side view of an exemplary mold having multiple funnels for introducing the foam into the mold to form a head restraint assembly according to the subject invention;

FIG. 9A is a perspective view of an exemplary interior component in the form of a head restraint according to the subject invention;

FIG. 9B is a perspective view of an exemplary interior component in the form of an interior trim panel according to the subject invention;

FIG. 9C is a perspective view of an exemplary interior component in the form of an armrest according to the subject invention;

FIG. 9D is a perspective view of an exemplary interior component in the form of a booster seat according to the subject invention;

FIG. 10A is a partial cross-sectional view of a foam assembly according to the subject invention; and

FIG. 10B is a partial cross-sectional view of a foam assembly according to the subject invention.

### DETAILED DESCRIPTION OF THE ENABLING EMBODIMENTS

Referring to the Figures, wherein like numerals indicate like or corresponding parts throughout the several views, a method of making a foam assembly 20, such as a seating assembly 10, for use in connection with interior components, such as head restraint components, seat components and/or interior panels, is generally shown.

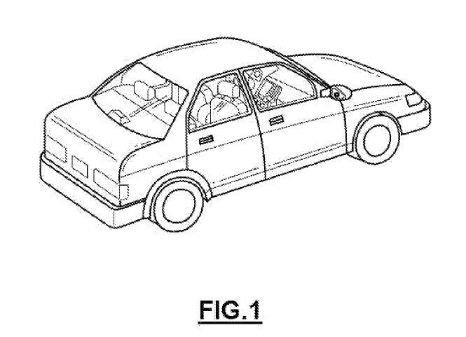

Referring generally to the figures and in particular FIG. 1, a vehicle is shown. The vehicle includes one or more vehicle seats provided for an occupant of the vehicle. While a vehicle is shown with reference to seat assemblies used in a vehicle, it should be understood that the present invention may be used in any other seats, or seat components, including, among others, office, airline and entertainment seating applications. In addition to seat and seat components, the process may be used in connection with forming any number of other interior components including for example, interior trim panels, booster seats, armrests, and bolsters.

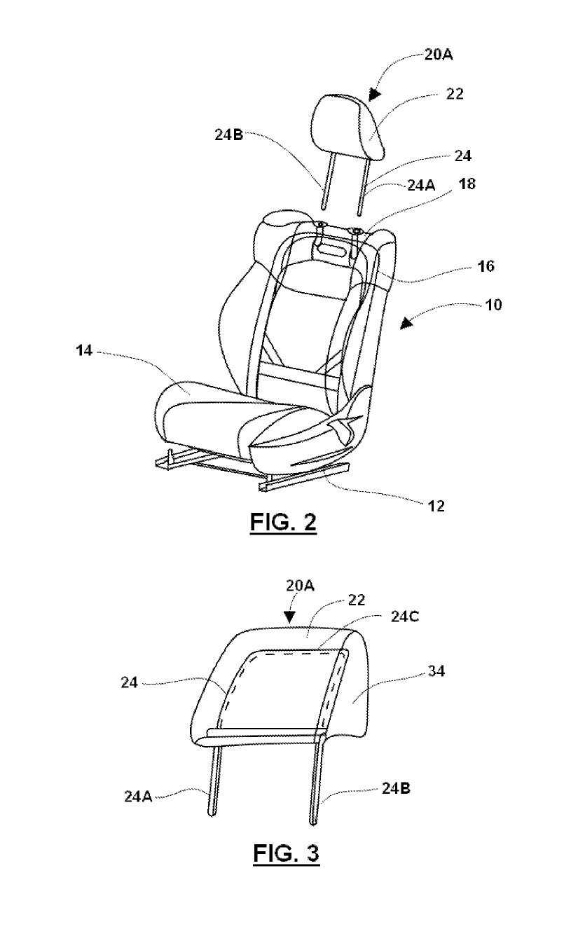

While the method may be applied to any interior component having a foam assembly 20, the present invention will be described in detail in reference to a head restraint assembly 20a of a seating assembly 10. The seating assembly 10, as shown in FIG. 2, includes a seat track 12 and seating components including a seat base 14 connected to a seatback 16 and a head restraint assembly 20a. The head restraint assembly 20a is shown here as disassembled from the seatback 16. The seatback 16 includes a seat frame shown in phantom.

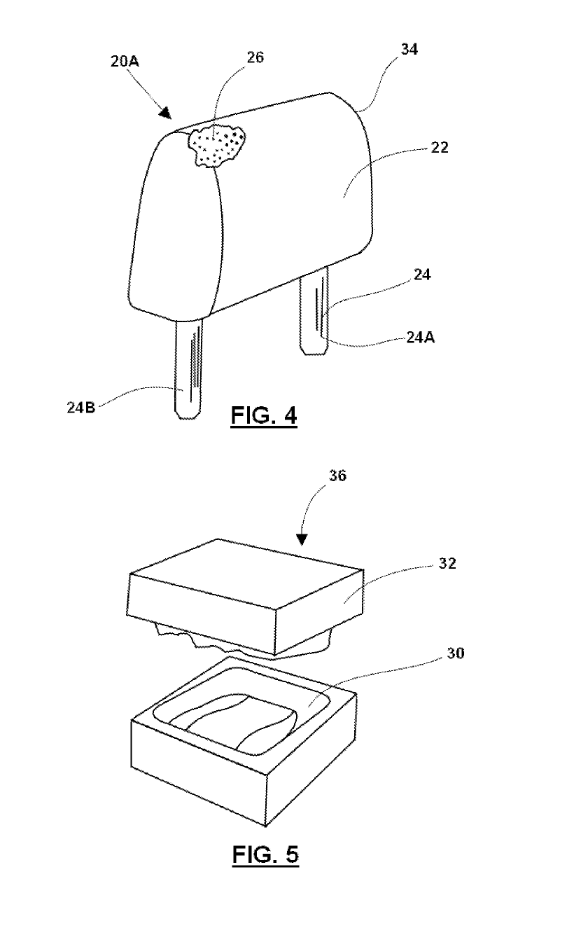

The head restraint assembly 20a is coupled to an upper end 18 of the seatback 16 with use of a mechanical structure which enables the head restraint assembly 20a to be raised and lowered with respect to such upper end 18 of the seatback 16. The head restraint assembly 20a includes a foam core or cushion portion, or otherwise referred to as the bun 22, and a post 24 formed integral with the cushion portion and shown in phantom in FIG. 3. The bun 22, in some cases, can also be surrounded by a surface material or cover stock forming an outer covering 34 such as leather, fabric, or any other material known in the art of interior components. The bun 22 may be formed of several types of materials including, for example, polyurethane foam shown at 26 in FIG. 4.

The foam core may be disposed about a post portion 24 having at least one post 24 that extends from the foam core to engage the foam core to a second interior component. In reference to the preceding description, the post 24 may be used to couple the head restraint assembly 20a to the seatback 16. The post 24 is typically formed into a u-shaped structure of high strength steel but may be any shape or material known in the art. In the exemplary head restraint assembly 20a, the u-shaped structure includes two posts 24A, 24B provided for mating with the seatback 16 and a lateral section 24C extending between each of the two posts 24A, 24B for use in mating with the bun 22 to form the head restraint assembly 20a.

As shown in FIG. 5, head restraint assemblies 20 are typically made in a mold 36. The mold 36 includes a bowl 30 and a lid 32. The bowl 30 is designed to provide the final shape of the bun 22 of the head restraint assembly 20a after completion of the mold process. The lid 32 typically includes a fixture (not shown) for holding the head restraint frame or posts 24 while molding the foam core or bun 22 thereon. While the lid 32 may include a fixture (not shown) for holding the head restraint frame or posts 24, the bowl 30 may include a fixture (not shown) for holding the head restraint frame or posts 24 as well.

During the method of forming a head restraint assembly 20a having a post 24 and bun 22, the post 24 is initially inserted into the fixture on the lid 32. The soft foam C and hard foam A are then poured into the bowl 30 and the lid 32 is closed thereby causing the post 24 to be disposed in the foam core in a predetermined manner. Heat is applied over a predetermined amount of time to the bowl 30 and lid 32 of the mold 36, thereby causing the foam to adhere to the post 24 while being hardened into the corresponding shape of the mold 36. After such predetermined time has passed, the lid 32 is opened and the post 24 having the foam core molded thereto forming the bun 22 is removed from the lid 32 fixture to thereby provide a finally formed head restraint assembly 20a.

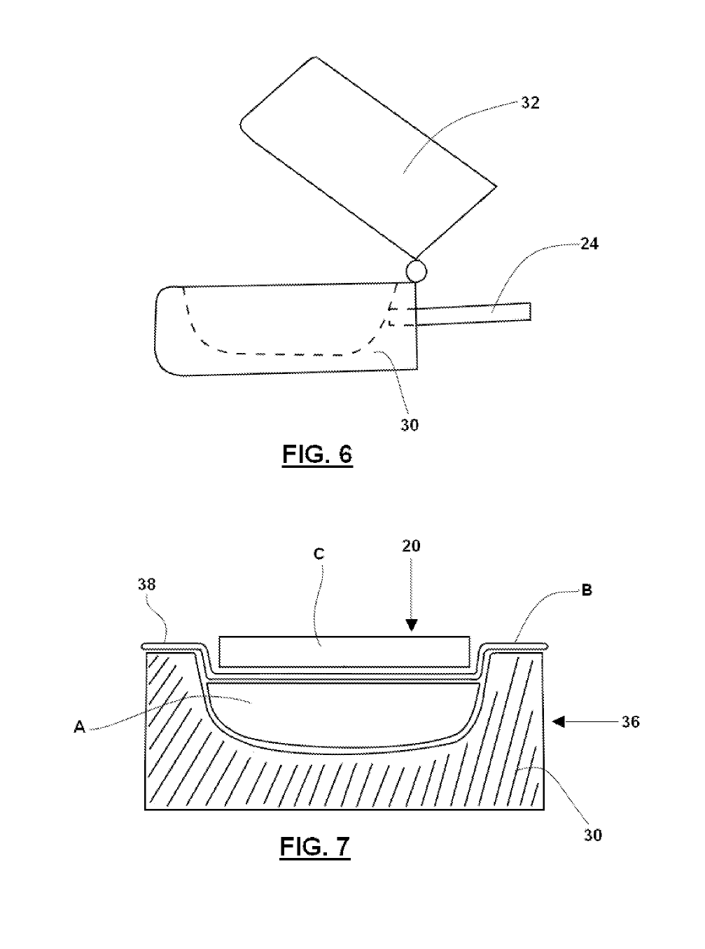

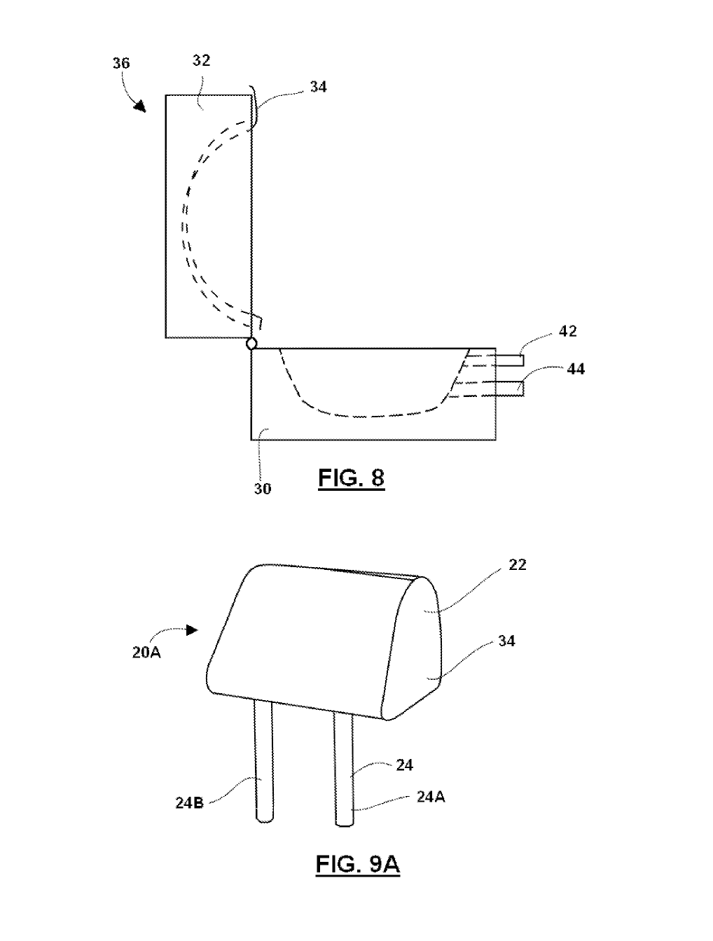

One embodiment of the subject invention is shown in FIGS. 6 and 7, and includes a foam core for use as a bun 22 of a head restraint assembly 20a. In this embodiment, the bowl 30 is shaped to correspond with the resultant shape of the bun 22. A hard foam A is poured into the bowl 30. A film B, such as although not limited to, an impervious film or barrier 38, is applied over the bowl 30 and thereafter, a soft foam C is poured onto the film B. The lid 32 is closed and a foam core for use with a head restraint assembly 20a is molded based on traditional methods of time and temperature. After forming, the resultant product is a head restraint assembly 20a with a bun 22 having a soft foam C and a hard foam A.

The hard foam A of the foam core or bun 22 has a first density. The first density of the hard foam A is a higher density foam that provides firmness and support to the foam core. The hard foam A may be a polyurethane foam 26, such as a high density polyurethane foam 26, or any other foam known in the art.

The soft foam C of the foam core or bun 22 has a second density that is different from the first density of the hard foam A. The second density of the soft foam C is a lower density foam that is less than the first density of the hard foam A. The second density of the soft foam C provides comfort and feel to the foam core. The soft foam C may be a polyurethane foam 26, such as a low density polyurethane foam 26, or any other foam known in the art.

The soft foam C and hard foam A are separate and distinct from one another. The soft foam C of the foam core, is the portion of the foam core that a user will engage. That is, if the foam core is used as a head restraint assembly 20a, the user's head would rest against the soft foam C during use. If the foam core is used as an armrest, the user's arm would rest on the soft foam C during use.

The film B may be an impervious barrier 38 that is disposed between the hard foam A and the soft foam C to separate the hard foam A and the soft foam C. In the exemplary embodiment, the impervious barrier 38 is a film B that is disposed between the hard foam A and the soft foam C. In an alternative embodiment, the impervious barrier 38 is a skin layer on the hard foam A that is disposed between the hard foam A and the soft foam C. The impervious barrier 38 may be any barrier known in the art for maintaining separation between foam portions.

In another embodiment of the subject invention, the method includes all of the steps as provided in the preceding paragraphs except, the lid 32 can be closed after the film B is placed in the bowl 30 and the soft foam C can be injected into the mold 36 through a funnel 42, for example, located in the lid 32 or bowl 30. The funnel 42 is a tubular portion defined in either the bowl 30 or lid 32 of the mold 36 to deliver the hard and soft foams A, C to the mold 36.

In another embodiment, instead of the film B used in both of the foregoing embodiments, a hard foam A can be selected to provide a skin layer similar to the function of the film B and formed in the mold 36 adjacent the soft foam C.

In another embodiment of the subject invention, a trim cover or outer covering 34 may be provided and disposed in the lid 32 with a laminate layer 40 attached thereto. The laminate layer 40 may or may not include an impervious barrier and is used to separate the outer covering 34 from the foam core or bun 22. After the lid 32 having the trim cover is closed in sealing engagement with the bowl 30, at least two different funnels, a first funnel 42 and a second funnel 44, can be used to inject two different foams into the mold 36. For example, a soft foam C can be injected into the mold 36 through the first funnel 42 and a hard foam A can be injected into the mold 36 through the second funnel 44. Thereafter, based on time and temperature, a final foam core is molded having a soft and hard foam C, A.

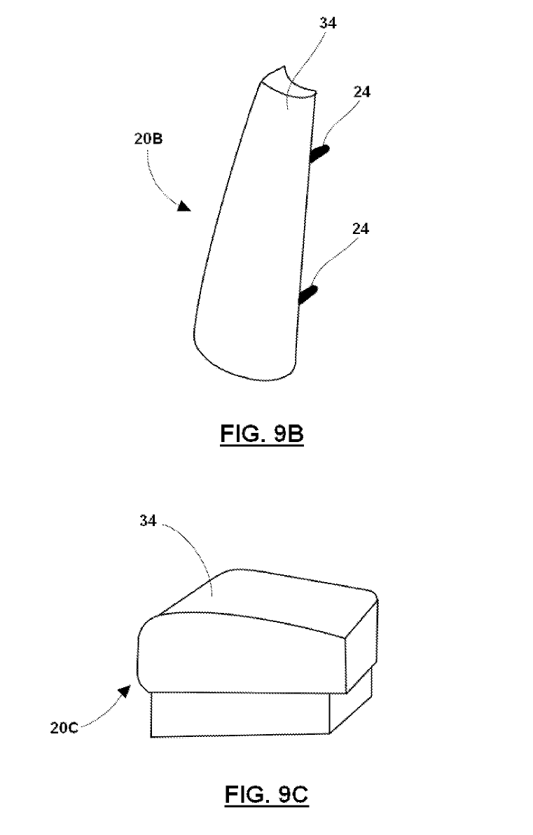

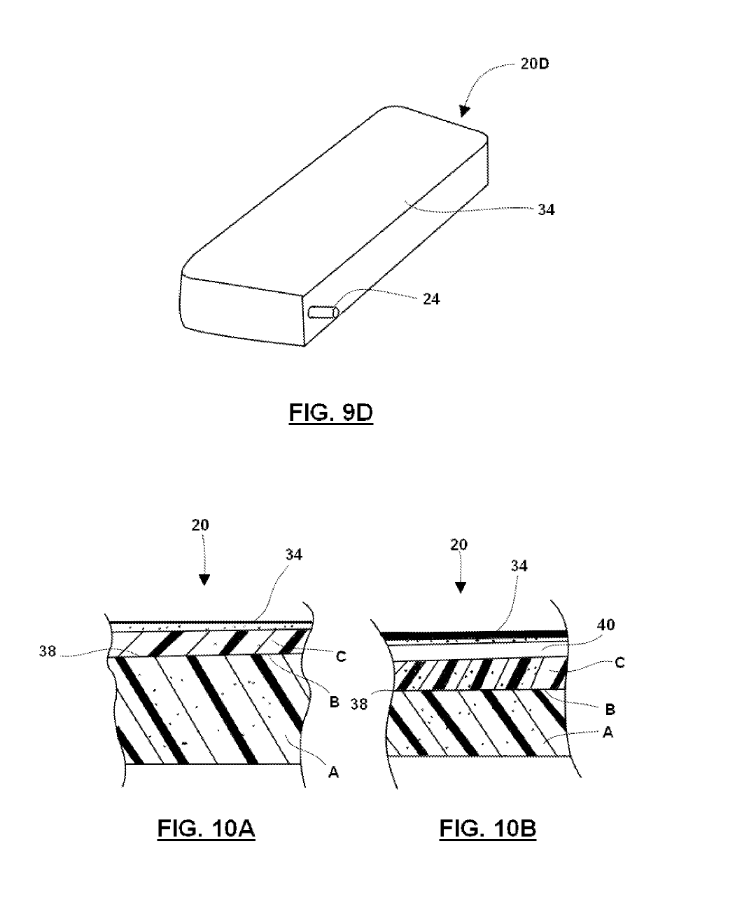

FIG. 9 is provided to demonstrate that the foregoing process can be used in connection with forming any number of other interior components including for example, interior trim panels 20b, booster seats 20c, armrests 20d, bolsters, and seat cushions.

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

We claim:

1. A method for making a foam core for use as an interior component in an automobile comprising the steps of:
distributing a hard foam having a first density for providing firmness and support to the foam core into a mold;
distributing a soft foam having a second density that is less than the first density for providing comfort and feel to the foam core into the mold; and
heating the mold to solidify the hard foam and soft foam to form the foam core.

2. The method as set forth in claim 1 further including the step of disposing an impervious barrier between the hard foam and the soft foam for separating the hard foam and the soft foam.

3. The method as set forth in claim 2 wherein the disposing an impervious barrier step is further defined as disposing a film between the hard foam and the soft foam for separating the hard foam and the soft foam.

4. The method as set forth in claim 2 wherein the disposing an impervious barrier step is further defined as forming a skin layer on the hard foam to separate the hard foam and the soft foam.

5. The method as set forth in claim 1 wherein the distributing the soft foam step is further defined as distributing a low density polyurethane foam into the mold.

6. The method as set forth in claim 1 wherein the distributing the hard foam step is further defined as distributing a high density polyurethane foam into the mold.

7. The method as set forth in claim 1 wherein the distributing the soft foam step is further defined as distributing the soft foam into a mold through a funnel.

8. The method as set forth in claim 7 wherein the distributing the hard foam step is further defined as distributing the hard foam into a mold through a funnel.

9. The method as set forth in claim 1 further including the step of placing a post portion into the mold for engaging the foam core.

10. The method as set forth in claim 1 further including the step of applying a mold lid to a mold bowl to seal the mold prior to the heating the mold step.

11. The method as set forth in claim 1 further including the step of disposing an outer covering over the foam core.

12. A foam assembly for use as an interior component in an automobile, the foam assembly comprising:
a foam core having a hard foam and a soft foam, said hard foam having a first density for providing firmness and support to said foam core and said soft foam having a second density that is less than said first density for providing comfort and feel to said foam core.

13. The foam assembly as set forth in claim 12 further including an impervious barrier disposed between said hard foam and said soft foam for separating said hard foam and said soft foam.

14. The foam assembly as set forth in claim 12 wherein said foam core is disposed about a post portion having at least one post that extends from said foam core for engaging said foam core to a second interior component.

15. The foam assembly as set forth in claim 12 wherein said soft foam is a low density polyurethane foam and said hard foam is a high density polyurethane foam.
